(19) United States
(12) Patent Application Publication
(10) Pub. No.: US 2006/0106739 A1
(43) Pub. Date: May 18, 2006

(54) CREATION OF FUTURE TIME INTERVAL POWER GENERATION DATA USING HISTORICAL DATA

(75) Inventors: Bryan Holzbauer, Gardnerville, NV (US); Scott Williams, Minden, NV (US); James A. Maxson, Minden, NV (US); Shane Jenkins, Minden, NV (US); Stephen Kwan, Minden, NV (US); Richard Gomer, Carson City, NV (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/904,493

(22) Filed: Nov. 12, 2004

(51) Int. Cl. G06F 17/00

(52) U.S. Cl. 705/412; 700/291

(57) ABSTRACT

Methods, apparatus, and articles of manufacture such as software media for creating projected power production data are described herein. The method may comprise storing historical heat rate data for at least one power generation unit in a historical heat rate database. The method may also comprise retrieving the historical heat rate data from the database for a selected time interval and creating a projected cost curve and/or a projected price curve for a future time interval based on the historical heat rate data.

### BACKGROUND OF THE INVENTION

The power generation industry has been increasingly opened to free market competition. As part of this new regulatory environment, Independent Systems Operators (ISOs) have emerged. Although rules may vary in a specific ISO environment, for background purposes it is fair to say that, as part of planning for daily operation, a bidding process occurs wherein power utilities submit estimates and bids to provide power in a region for the next day. These estimates typically state the cost to generate power for the next day, and also state the seller's asking price for the next day. From these bids, a seller(s) is selected to supply power to a region for the next day. Therefore, success in the bidding process is critical to the success of a seller.

At present, these estimates or bids are generated manually by experienced employees using their personal and subjective “best guess.” Therefore, the success of the bid process varies and is dependent upon the skill and experience of the employee. Thus, a system for generating bids is needed in the power generation industry.

### BRIEF DESCRIPTION OF THE INVENTION

Methods, apparatus, and articles of manufacture such as software media for creating projected power production data are disclosed. The method may comprise storing historical heat rate data for at least one power generation unit in a historical heat rate database. The method may also comprise retrieving the historical heat rate data from the database for a selected time interval and creating a projected cost curve and/or a projected price curve for a future time interval based on the retrieved historical heat rate data.

### BRIEF DESCRIPTION OF THE DRAWINGS

The following description of the figures is not intended to be, and should not be interpreted to be, limiting in any way.

FIG. 1 is a graph of a historical heat rate curve of an exemplary embodiment;

FIG. 2 is a high level flow chart of an exemplary embodiment;

FIG. 3 is a graph of a day-ahead curve of an exemplary embodiment;

FIG. 4 is a table showing the individual values for a day-ahead curve of an exemplary embodiment.

FIG. 5 is a diagram of exemplary hardware associated with the system.

### DETAILED DESCRIPTION OF THE INVENTION

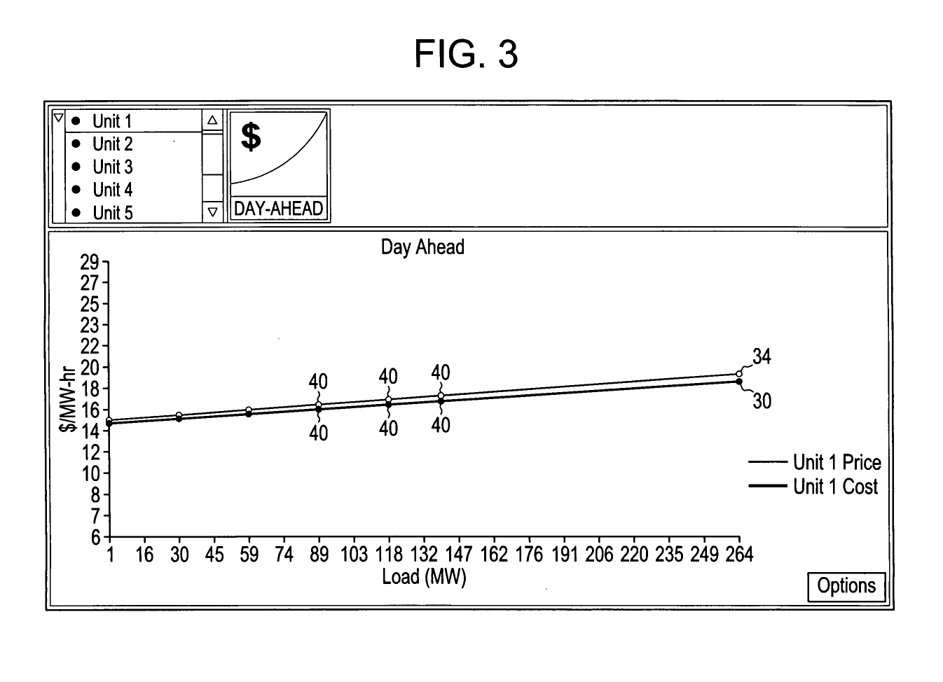

As shown in one exemplary embodiment at FIG. 3, the present system may generate and display a “day-ahead” cost curve 30 and a day-ahead price curve 34 which may be used for bidding by power utilities. However, it is possible for the system to generate data for any projected time interval in the future, so “day-ahead” as used in this disclosure should not be interpreted as limited to one day or 24 hours. Additionally, all curves are made of plotted data points so generating the data points and presenting, storing, or manipulating the data points as a table or as individual data points is also with in the scope of this disclosure and within what is meant by “a curve.” The day-ahead cost curve 30 and the day-ahead price curve 34 may show the cost and price per megawatt hour plotted against the produced load in megawatts. Although the period shown in the day-ahead curve may be set to any duration including for example 15 minutes, 1 hour, or 1 day, the day-ahead cost curve 30 and the day-ahead price curve 34 in this embodiment estimates the costs and price, respectively, for a 24 hour “day-ahead” period from 12 AM of the next day to 12 AM of the following day. The curves may be computed by the system and displayed to a user in any suitable format as shown in FIG. 3, for example.

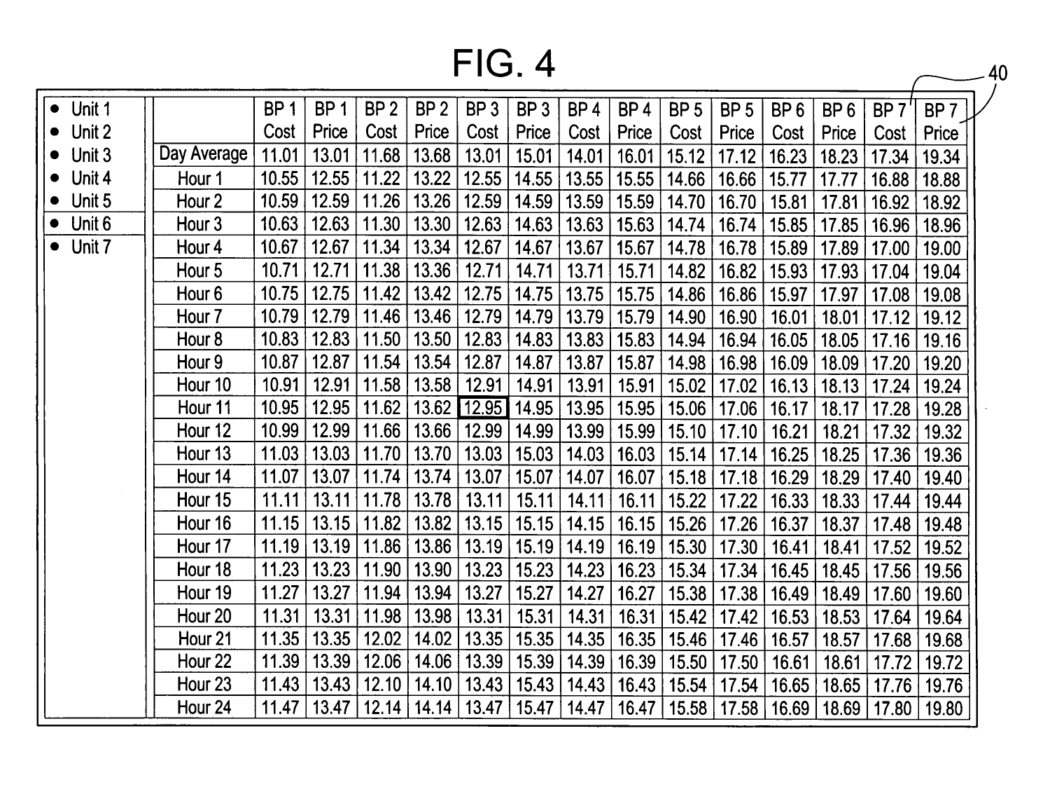

As shown in FIG. 4, the use of any number of “breakpoints” 40 which are megawatt load points, i.e., 1 megawatt, 100 megawatts, etc. can be used to show costs and prices at chosen megawatt levels. For example, in FIGS. 3 and 4 seven breakpoints 40 are used, see (BP 1) at 1 megawatt through (BP 7) at 264 megawatts. Breakpoints 40 may also be implemented in order to simplify the data presentation and to simplify the creation of a day-ahead curve 30. For example, the seven breakpoints 40 (BP 1-BP 7) are used to make the table at FIG. 4 that displays to a user the cost and price of power in dollars at each breakpoint 40 at each hour during a 24-hour period. Of course, this is one exemplary embodiment and other configurations of breakpoints 40 and time intervals may also be used.

Thus, with above in mind, it will be discussed below how a day-ahead curve 30 may be generated in an exemplary embodiment.

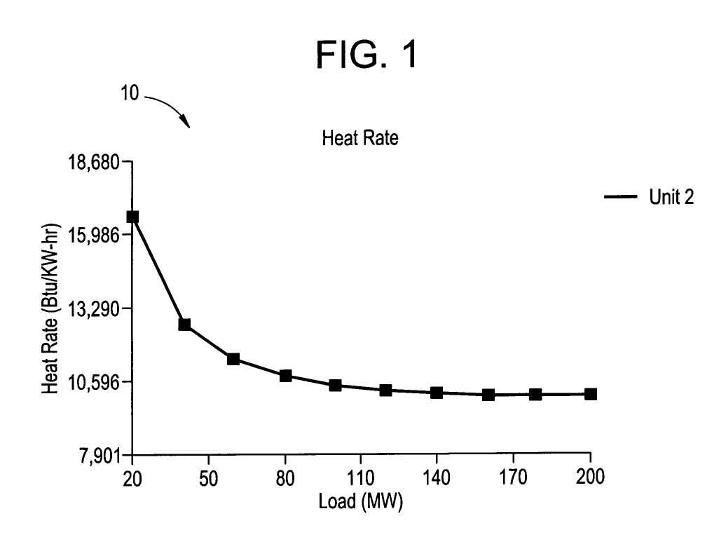

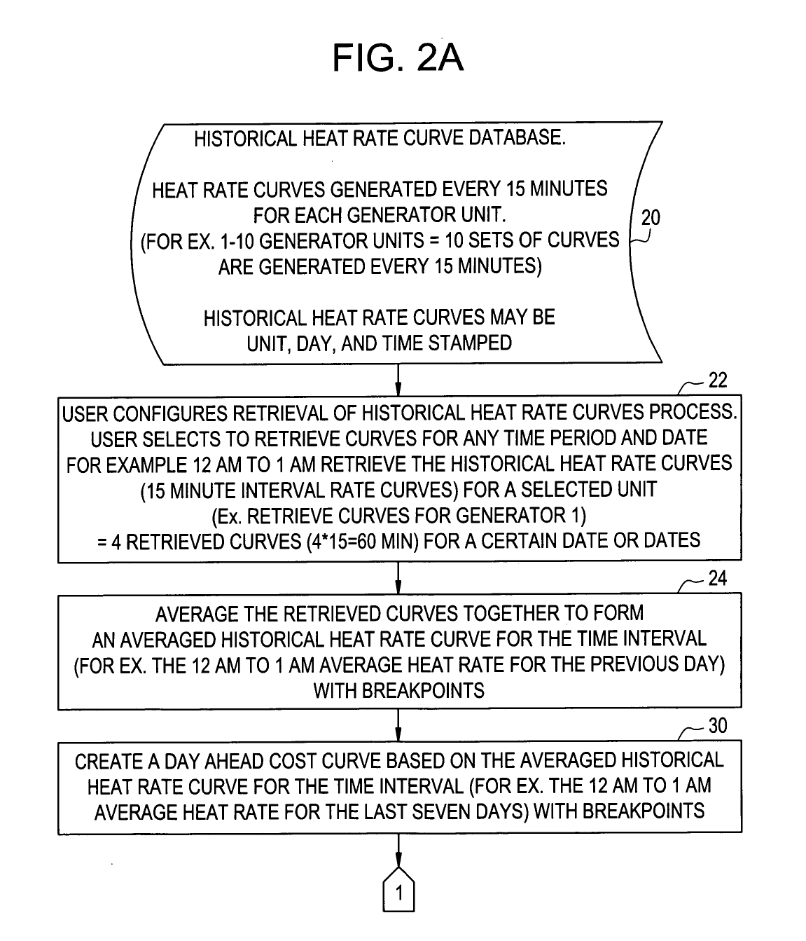

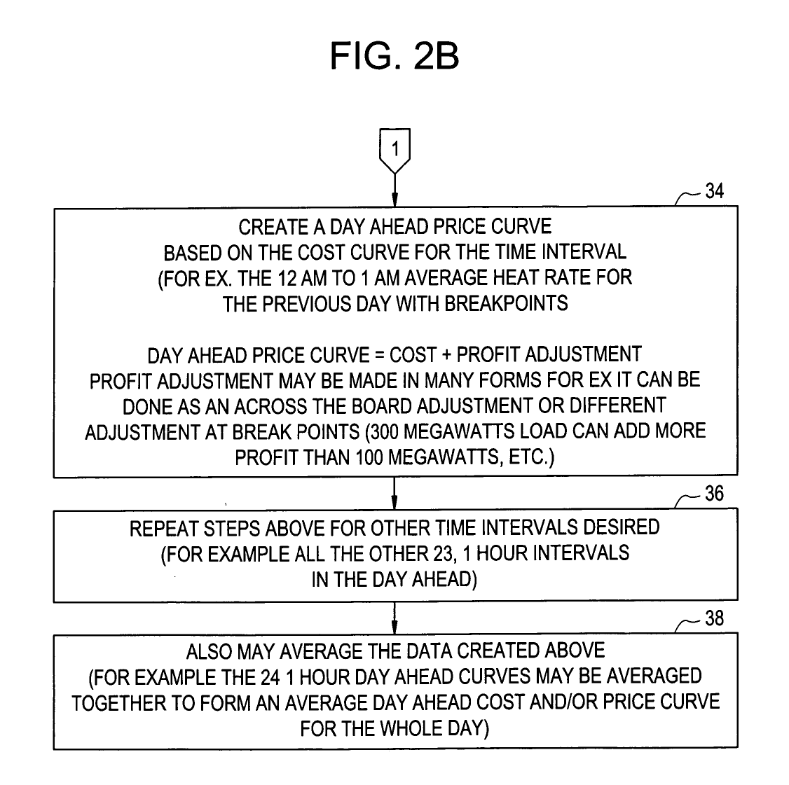

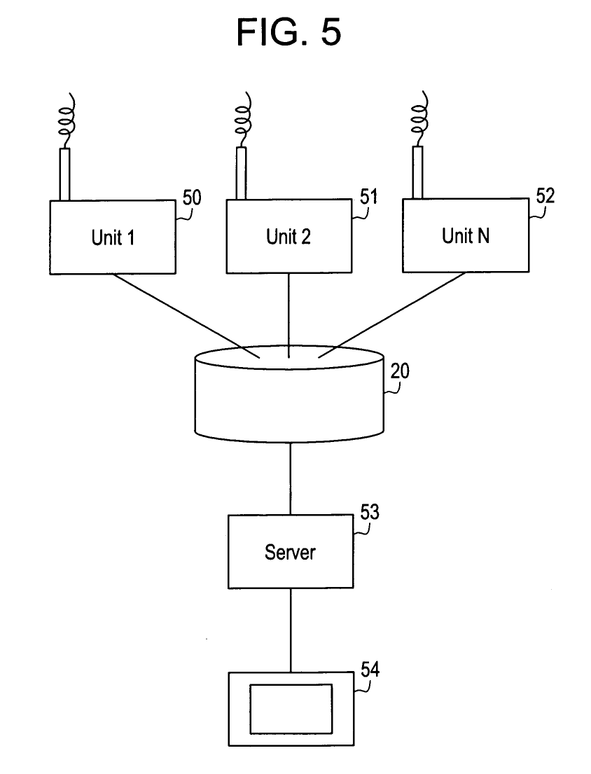

As shown in FIG. 1 “Heat Rate” 10 is a term of art in power generation and may be graphed against load for example. Heat Rate 10 is expressed in Btu per Kilowatt-Hour which indicates how much heat is required to be maintained to generate 1 Kilowatt of electricity per hour. Heat Rate 10 can also be thought of as the inverse of efficiency given that due to the intentional design of a power generation unit, it is usually more efficient to produce larger amounts of power. For example, a typical power generation unit is designed so that it is more efficient for the unit to produce 200 megawatts than it is to produce 20 megawatts. This can be seen in FIG. 5, wherein in the example shown, the Heat Rate 10 shows that a power generation unit requires about 17,000 Btu per KW-hr to produce 20 megawatts of power whereas it only requires about 10,000 Btu per KW-hr to produce 200 megawatts of power. Thus, in power generation units, due to the unit's design it is usually more efficient to produce more power than it is to produce less power. The exemplary graph of Heat Rate at FIG. 5 shows this relationship. As with other operating conditions experienced by a power plant, the actual Heat Rate 10 experienced may be recorded and stored for any time period including days, hours, every 15 minutes, or in real time for example. Herein this historical data is termed, historical heat rate data 20 and is stored in at least one historical heat rate database 20 as shown in FIG. 2. The Heat Rate data may be stored as curves or data points in a table, or any other form. Additionally, all curves are made of plotted data points so generating the data points and presenting, storing, or manipulating the data points as a table or as individual data points is also with in the scope of this disclosure and within what is meant by “a curve.” As they are a measure of efficiency, the stored historical heat rate curves 5 which are stored in the historical heat rate database 20 may be used to calculate any needed day-ahead cost curves 30 and day-ahead price curves 34, as described in detail below.

As shown in FIGS. 1 and 2, in this embodiment, in order to generate the day-ahead cost curves 30 and the day-ahead price curves 34, a set of historical heat rate curves 5 have been previously generated and stored in a historical heat rate database 20 for retrieval. It is important to note in FIG. 2 that various examples are also provided to explain this embodiment but these examples should not be considered to be limiting to the overall scope of the disclosure. For example, all forms of heat rate data may be used. Additionally, all curves are made of plotted data points so generating the data points and presenting, storing, or manipulating the data points as a table or as individual data points is also with in the scope of this disclosure and within what is meant by “a curve” or “curve database.” In this embodiment, the historical heat rate curve database 20 contains historical heat rate curves 5 taken from the previous day of the power generation units 50-52. However, the historical heat rate curve database 20 may also include historical heat rate curves 10 containing heat rate curves 10 and/or additional data for any number of past days of operation of a power generation unit.

In FIG. 2, the system and method shown may be implemented in software programming code or software modules for example in a computer system having access to historical heat rate database 20 as shown in FIG. 5 for example. As shown in FIG. 2, the historical heat rate curve database 20 in this embodiment stores historical heat rate curves 5 which were generated during the prior day every fifteen minutes for the entire prior day for a particular power generation unit, for example generator unit 150. However, any time interval may be used depending upon the users needs. In this embodiment, the historical heat rate database 20 stores sets of historical heat rate curves 5 taken every fifteen minutes for ten different power generation units. Thus, in this embodiment, 10 sets of historical heat rate curves 5 are generated and stored every fifteen minutes. The historical heat rate curves 5 may be time stamped, date stamped, and associated or indexed with a particular unit, i.e., power generator 1, in order to aid in data retrieval.

In FIG. 2, at reference numeral 22, in this embodiment the user configures a retrieval configuration 22 via a user interface 54 for example. For example, the user selects power generator unit 150 as the unit to be studied, and the user selects the time period of 12 AM to 1 AM from which to retrieve the historical heat rate curves 5. Thus, as the curves cover 15 minute intervals in this embodiment, 4 curves would be retrieved in one hour. Of course, a pre-set or automated program can also be run so that user input is not required. In this example however, the user knows that unit 1 will be run on the day-ahead, so the user wants to focus on unit 1 at this point. Continuing with the explanation of this embodiment, the retrieved historical heat rate curves 5 may be averaged together to form an averaged historical heat rate curve 24. This averaged historical heat rate curve 24 has breakpoints 40 located at any desired megawatt levels. Furthermore, the heat rate curve can then be used to calculate a cost curve and the cost of power generation using fuel cost. For example, although many formulas are possible to calculate cost, an example of one formula that computes cost as a function of load is Cost ($/hr)=Fuel Cost ($/mmBtu)×Heat Input (mmBtu/hr), where Heat Input (mmBtu/hr)=Load (MW)×Heat Rate (mmBtu/MW-hr). Fuel cost ($/mmBtu) may be stored in the historical heat rate database 20 for the time interval selected or in any storage means. Any desired megawatt levels or breakpoints 40 as related to cost (cost per megawatt) might be taken from the curve or computed. Another example of a cost formula which could be used would also add expenses such as the cost of emissions and fixed costs. For example, the following formula is such a formula: Cost ($/hr)={Fuel Cost ($/mmBtu)+NOx Price ($/lb NOx)×NOx Generation (lb NOx/mmBtu)}×Heat Input (mmBtu/hr)+Ash Costs ($/hr)+Sulfur Costs ($/hr)+Operation and Maintenance Costs ($/hr)+Fixed Costs ($/hr). Any of these added expense values could also be stored in historical heat rate curve database 20 for the time interval selected or in other storage. Thus, a resultant cost curve which can be used as a day-ahead cost curve 30 as shown in FIGS. 2 and 3 may be formed for the 1 hour interval from 12 AM to 1 AM, for example. This day-ahead cost curve 30 may be stored for example in the server computer 53. It is also possible, in an alternative embodiment, to not average the historical heat rate curve 5 and to use the historical heat rate curve 5 directly to compute a day-ahead cost curve 30 for the time interval that corresponds to the historical heat rate curve 5. The above process of creating the day-ahead cost curve 30 may also be termed “modeling” because a model of projected costs is created which may be used for bidding to sell power.

A day-ahead price curve 34 may be formed from the day-ahead cost curve 30. The day-ahead price curve 34 is equal to cost plus any desired profit adjustment. The profit adjustment many take any form desired. For example, a constant multiplier may be applied equally to the day-ahead cost curve 30 or alternatively different profit adjustments with different multipliers may be used at different breakpoints 40. For example, a 100 megawatt breakpoint 40 may be selected to be associated with a lower profit adjustment (for example cost*1.2) than a 500 megawatt breakpoint 40 profit adjustment (cost*1.5) depending on the desired profit. For example, continuing with the explanation of this embodiment, as seen in FIG. 2 at reference numeral 34 a day-ahead price curve 34 is created based on the day-ahead cost curve 30 for the time interval from 12 A.M. to 1 A.M. Thus, by following the process above the day-ahead cost curve 30 and the day-ahead price curve 34 have been generated for the time interval between 12 A.M. and 1 A.M. These curves may be stored for example in the server 53. In FIG. 2, at reference numeral 36 the process above can be repeated to generate the day-ahead cost curve 30 and the day-ahead price curve 34 for the other 23 one hour time intervals of the day-ahead for example and these 24 day-ahead values may be displayed to the user for example in the table of FIG. 4 and/or displayed as a curve as in FIG. 3. Of course any other suitable display format may also be used.

Additionally, as shown in FIG. 2 at reference numeral 38 another average may computed. For example continuing with the example of this embodiment, an average may be taken of the 24 day-ahead cost curves 30 to form a daily average day-ahead cost curve 38. Likewise, a daily average day-ahead price curve 39 may also be computed.

Of course, any computed resultant day-ahead data discussed above may be displayed to the user as a curve 34 as shown in FIG. 3 or as a table as shown in FIG. 4 via user interface 54 and may be stored or exported for use in generating bids to be submitted by the power utility.

For a user or a power company acting as a seller, a number of advantages, and technical contributions accrue from the above disclosed embodiments, some of which are discussed below. For example, instead of relying on a human generated best guess to forecast reasonable costs and prices for the day-ahead in order to generate a formal bid, and thus for the power company to be economically successful in bidding, actual historical heat rate data can be relied on instead. This leads to more accurate and thus more successful bidding. For example, in the embodiment above, historical heat rate data from the previous day is used and has been found to be an excellent estimator of day-ahead costs. This is simply because it has been found as a business model that conditions experienced on the day-ahead are likely to be similar to conditions experienced on the day or days before the day-ahead. However, as explained above, any time interval can be configured to be examined by the user at 22 in FIG. 2. Thus, if historical heat rate curves from a day 10 days ago are desired to be used in the above process as well, this data may be used. Additionally, any number of day-ahead curves may be generated, and any number of averages may be taken against any configuration of the previous day's data. Thus, only the amount and content of the data in the historical heat rate curve database 20 may limit the iterations and/or averages that a user may select to have performed in the above system.

As shown in FIGS. 1-5, the present system, methods, and apparatus, may be embodied as software and/or hardware in a computer system, for example as shown in FIG. 5, as a software program or product code for any desired number of power generation units (50-52). The computer system may have a user interface 54 and may have access to a historical heat rate database 20. The embodiments described herein are also not limited to any particular type of fuel source or type of power generation unit or plant, including coal, oil, gas or other fuel source.

FIG. 5 illustrates an example of a suitable computing system environment in which the methods and apparatus described above and/or claimed herein may be implemented. The computing system environment is only one example of a suitable computing environment and is not intended to suggest any limitation as to the scope of use or functionality of the invention. Neither should the computing environment shown in FIG. 5 be interpreted as having any dependency or requirement relating to any one or combination of components illustrated in the exemplary operating environment in FIG. 5.

One of ordinary skill in the art can appreciate that a computer or other client or server device can be deployed as part of a computer network, or in a distributed computing environment. In this regard, the methods and apparatus described above and/or claimed herein pertain to any computer system having any number of memory or storage units, and any number of applications and processes occurring across any number of storage units or volumes, which may be used in connection with the methods and apparatus described above and/or claimed herein. Thus, the same may apply to an environment with server computers and client computers deployed in a network environment or distributed computing environment, having remote or local storage. The the methods and apparatus described above and/or claimed herein may also be applied to standalone computing devices, having programming language functionality, interpretation and execution capabilities for generating, receiving and transmitting information in connection with remote or local services.

The methods and apparatus described above and/or claimed herein is operational with numerous other general purpose or special purpose computing system environments or configurations. Examples of well known computing systems, environments, and/or configurations that may be suitable for use with the methods and apparatus described above and/or claimed herein include, but are not limited to, personal computers, server computers, hand-held or laptop devices, multiprocessor systems, microprocessor-based systems, network PCs, minicomputers, mainframe computers, distributed computing environments that include any of the above systems or devices.

The methods described above and/or claimed herein may be described in the general context of computer-executable instructions, such as program modules, being executed by a computer. Program modules typically include routines, programs, objects, components, data structures, etc. that perform particular tasks or implement particular abstract data types. Thus, the methods and apparatus described above and/or claimed herein may also be practiced in distributed computing environments such as between different power plants or different power generator units (50-52) where tasks are performed by remote processing devices that are linked through a communications network or other data transmission medium. In a typical distributed computing environment, program modules and routines or data may be located in both local and remote computer storage media including memory storage devices. Distributed computing facilitates sharing of computer resources and services by direct exchange between computing devices and systems. These resources and services may include the exchange of information, cache storage, and disk storage for files. Distributed computing takes advantage of network connectivity, allowing clients to leverage their collective power to benefit the entire enterprise. In this regard, a variety of devices may have applications, objects or resources that may utilize the methods and apparatus described above and/or claimed herein.

Computer programs implementing the method described above will commonly be distributed to users on a distribution medium such as a CD-ROM. The program could be copied to a hard disk or a similar intermediate storage medium. When the programs are to be run, they will be loaded either from their distribution medium or their intermediate storage medium into the execution memory of the computer, thus configuring a computer to act in accordance with the methods and apparatus described above.

The term “computer-readable medium” encompasses all distribution and storage media, memory of a computer, and any other medium or device capable of storing for reading by a computer a computer program implementing the method described above.

Thus, the various techniques described herein may be implemented in connection with hardware or software or, where appropriate, with a combination of both. Thus, the methods and apparatus described above and/or claimed herein, or certain aspects or portions thereof, may take the form of program code or instructions embodied in tangible media, such as floppy diskettes, CD-ROMs, hard drives, or any other machine-readable storage medium, wherein, when the program code is loaded into and executed by a machine, such as a computer, the machine becomes an apparatus for practicing the methods and apparatus of described above and/or claimed herein. In the case of program code execution on programmable computers, the computing device will generally include a processor, a storage medium readable by the processor which may include volatile and non-volatile memory and/or storage elements, at least one input device, and at least one output device. One or more programs that may utilize the techniques of the methods and apparatus described above and/or claimed herein, e.g., through the use of a data processing, may be implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of described above and/or claimed herein may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or a receiving machine having the signal processing capabilities as described in exemplary embodiments above becomes an apparatus for practicing the method described above and/or claimed herein. When implemented on a general-purpose processor, the program code combines with the processor to provide a unique apparatus that operates to invoke the functionality of the methods and apparatus of described above and/or claimed herein. Further, any storage techniques used in connection with the methods and apparatus described above and/or claimed herein may invariably be a combination of hardware and software.

While the methods and apparatus described above and/or claimed herein have been described in connection with the preferred embodiments and the figures, it is to be understood that other similar embodiments may be used or modifications and additions may be made to the described embodiment for performing the same function of the methods and apparatus described above and/or claimed herein without deviating therefrom. Furthermore, it should be emphasized that a variety of computer platforms, including handheld device operating systems and other application specific operating systems are contemplated, especially given the number of wireless networked devices in use.

Thus, a system, method, and apparatus for generating bids for the power generation industry has been described above.

While the methods and apparatus described above and/or claimed herein are described above with reference to an exemplary embodiment, it will be understood by those skilled in the art that various changes may be made and equivalence may be substituted for elements thereof without departing from the scope of the methods and apparatus described above and/or claimed herein. In addition, many modifications may be made to the teachings of above to adapt to a particular situation without departing from the scope thereof. Therefore, it is intended that the methods and apparatus described above and/or claimed herein not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another.

What is claimed is:

1. A method for creating projected power production data comprising:
storing historical heat rate curves for at least one power generation unit in a historical heat rate curve database;
retrieving at least one historical heat rate curve from the database for a selected time interval; and
creating a projected cost curve for a future time interval based on the at least one retrieved historical heat rate curve.

2. The method of claim 1 further comprising:
creating a projected future price curve based on the projected cost curve and at least one profit adjustment.

3. The method of claim 1 wherein the creating the projected cost curve for a future time interval from the at least one retrieved historical heat rate curve comprises:
providing breakpoints at load levels of produced power in the at least one historical heat rate curve; and
providing the breakpoints at load levels of produced power also in the created projected cost curve.

4. The method of claim 1 wherein the creating the projected cost curve for a future time interval from the at least one retrieved historical heat rate curve comprises:
computing the projected cost curve from breakpoints located at load levels of produced power in the at least one historical heat rate curve.

5. The method of claim 1 wherein the retrieving at least one historical heat rate curve from the database for a selected time interval further comprises:
configuring the retrieving so that the selected time interval is selectable via a user interface.

6. The method of claim 1 wherein the creating the projected cost curve for a future time interval from the at least one retrieved historical heat rate curve comprises:
retrieving at least two historical heat rate curves from the database for a selected time interval; and
averaging the historical heat rate curves together to form an averaged historical rate curve to be used in the creating a projected cost curve for a future time interval.

7. The method of claim 1 wherein the method is repeated for additional selected time intervals.

8. The method of claim 6 wherein the method is repeated for additional selected time intervals and wherein the projected cost curves for each future time interval are averaged together to form an averaged projected cost curve for all of the additional selected time intervals.

9. The method of claim 7 wherein the method is repeated until the selected time intervals create a set of a projected cost curves covering a 24 hour period.

10. The method of claim 2 wherein the method is repeated for additional selected time intervals so that the additional selected time intervals create a set of a projected price curves covering a 24 hour period.

11. The method of claim 1 wherein the method of storing historical heat rate curves for at least one power generation unit in a historical heat rate curve database comprises:
stamping the heat rate curve with an identifying stamp.

12. An apparatus for creating projected power production data comprising:
a database for storing and retrieving historical heat rate data for at least one power generation unit; and
a computer having access to the database for creating projected future estimates of costs to produce power from the at least one power generation unit based on the historical heat rate data.

13. The apparatus of claim 12 wherein the computer also creates projected future estimates of prices to sell produced power from the at least one power generation unit based on the projected future estimates of costs.

14. The apparatus of claim 12 wherein the computer also produces a graphical representation on a display of the projected future estimates of costs to produce power from the at least one power generation unit based on the historical heat rate data.

15. The apparatus of claim 13 wherein the computer also produces a graphical representation on a display of the projected future estimates of price to sell produced power from the at least one power generation unit based on the historical heat rate data.

16. One or more computer-readable media having computer-readable instructions thereon which, when executed by a computer, cause the computer to:
retrieve at least one historical heat rate curve from a database for a selected time interval; and
create a projected cost curve for a future time interval from the at least one retrieved historical heat rate curve.

17. The computer-readable media of claim 16 further comprising instructions which cause the computer to:
create a projected future price curve based on the projected cost curve and at least one profit adjustment.

18. The computer-readable media of claim 16 further comprising instructions which cause the computer to:
provide breakpoints at load levels of produced power in the at least one historical heat rate curve; and
provide the breakpoints at load levels of produced power also in the created projected cost curve.

19. The computer-readable media of claim 16 further comprising instructions which cause the computer to:
compute the projected cost curve from breakpoints located at load levels of produced power in the at least one historical heat rate curve.

20. One or more computer-readable media having computer-readable instructions thereon which, when executed by a computer, cause the computer to:
receive a heat rate curve from a power generation unit;
stamp the heat rate curve with an identifying stamp; and
store the heat rate curve from the power generation unit in a historical heat rate curve database.

21. A method of a preparing a bid to sell power for a future time interval by modeling power generation costs and selling prices for a future time interval comprising:
storing historical heat rate curves for at least one power generation unit in a historical heat rate curve database;
retrieving at least one historical heat rate curve from the database for a selected time interval;
modeling a projected cost curve for a future time interval based on the at least one retrieved historical heat rate curve;
modeling a projected price curve for a future time interval based on the projected cost curve and a profit adjustment factor; and
creating a bid to sell power from the projected cost curve and the projected price curve for the future time interval.

22. The method of claim 21 wherein the modeling the projected cost curve for a future time interval from the at least one retrieved historical heat rate curve comprises:
providing breakpoints at load levels of produced power in the at least one historical heat rate curve; and
providing the breakpoints at load levels of produced power also in the created projected cost curve.

23. The method of claim 21 wherein the modeling the projected cost curve for a future time interval from the at least one retrieved historical heat rate curve comprises:
computing the projected cost curve from breakpoints located at load levels of produced power in the at least one historical heat rate curve.

24. The method of claim 21 wherein the retrieving at least one historical heat rate curve from the database for a selected time interval further comprises:
configuring the retrieving so that the selected time interval is selectable via a user interface.

25. The method of claim 21 wherein the modeling the projected cost curve for a future time interval from the at least one retrieved historical heat rate curve comprises:
retrieving at least two historical heat rate curves from the database for a selected time interval; and
averaging the historical heat rate curves together to form an averaged historical heat rate curve to be used in creating a projected cost curve for a future time interval.

26. The method of claim 21 wherein the method is repeated for additional selected time intervals.

27. The method of claim 21 wherein the method is repeated for additional selected time intervals and wherein the projected cost curves for each future time interval are averaged together to form an averaged projected cost curve for all of the additional selected time intervals.

28. The method of claim 26 wherein the method is repeated until the selected time intervals create a set of a projected cost curves and projected price curves covering a 24 hour period.

29. The method of claim 21 wherein the method of storing historical heat rate curves for at least one power generation unit in a historical heat rate curve database comprises:
stamping the heat rate curve with an identifying stamp.

30. A system for creating projected power production data comprising:
means for storing and retrieving historical heat rate data of at least one power generation unit; and
means for creating projected future estimates of costs to produce power from the at least one power generation unit based on the historical heat rate data.

31. The system of claim 30 further comprising:
means for creating projected future estimates of prices to sell the produced power from the at least one power generation unit based on the projected future estimates of costs.

32. The system of claim 30 further comprising:
means for producing a graphical representation of the projected future estimates of costs to produce power from the at least one power generation unit based on the historical heat rate data.

33. The system of claim 31 further comprising:
means for producing a graphical representation of the projected future estimates of price to sell produced power from the at least one power generation unit based on the historical heat rate data.

34. A method for creating projected power production data comprising:
storing historical heat rate data for at least one power generation unit in a historical heat rate database;
retrieving the at least one historical heat rate curve from the database for a selected time interval; and
creating a projected cost to produce power for a future time interval based on the at least one retrieved historical heat rate curve for the selected time interval.

35. The method of claim 34 further comprising:
creating a projected future price to produce power for the selected time interval based on the projected cost and at least one profit adjustment.

36. One or more computer-readable media having computer-readable instructions thereon which, when executed by a computer, cause the computer to:
retrieve historical heat rate data from a database for a selected time interval; and create a projected cost for a future time interval from the retrieved historical heat rate data.

37. A method of a preparing a bid to sell power for a future time interval by modeling power generation costs and selling prices for a future time interval comprising:
storing historical heat rate data for at least one power generation unit in a historical heat rate database;
retrieving the heat rate data from the database for a selected time interval; modeling a projected cost for a future time interval based on the retrieved historical heat rate data;
modeling a projected price for a future time interval based on the projected cost and a profit adjustment factor; and
creating a bid to sell power from the projected cost and the projected price for the future time interval.
